(19) United States
(12) Patent Application Publication
(10) Pub. No.: US 2016/0378272 A1
(43) Pub. Date: Dec. 29, 2016

(54) SYSTEMS AND METHODS FOR PROVIDING MULTI-FOCUS TO APPLICATIONS FOR COLLABORATION

(71) Applicant: Promethean Limited, Blackburn (GB)

(72) Inventors: David Prescott Whitlark, Woodstock, GA (US); Sriraman Venkataraman, Marietta, GA (US)

(21) Appl. No.: 15/196,432

(22) Filed: Jun. 29, 2016

Related U.S. Application Data
(60) Provisional application No. 62/186,098, filed on Jun. 29, 2015.

(51) Int. Cl. G06F 3/0481; G06F 9/52; G06F 3/0484; G09G 3/00; G06F 3/0488

(52) U.S. Cl. CPC G06F 3/0481; G09G 3/002; G06F 3/04886; G06F 3/0484; G06F 9/52; G06F 2203/04803; G06F 2203/04804

(57) ABSTRACT

A multi-focus application collaborative system is configured to allow: (1) two or more applications to be displayed on a multi-sensory input display; and one or more users to interact and provide input to the two or more applications at the same time without having to switch focus between the two or more applications. That is, each application retains focus simultaneously so that input from the one or more users is received by the two or more applications without the one or more users having to shift focus from one application to the other in order for each application to receive input from the multi-sensory input display.

### CLAIM OF PRIORITY

This application claims priority to U.S. Provisional Patent Application No. 62/186,098, filed Jun. 29, 2015, entitled, “Systems and Methods for Providing Multi-Focus to Applications for Collaboration,” the entire disclosure of which is incorporated herein by reference in its entirety.

### BACKGROUND

Interactive display systems are well known. A typical interactive display system provides for the display of an image on a vertical display surface, and detection of contact points on that display surface, to enable selection or manipulation of displayed images. Typically such a system providing a vertical display is used in an environment where an audience can see the display, such as a whiteboard in a classroom environment. However interactive systems are not limited to vertical display arrangements, and horizontal display arrangements may also be provided. In such an application a table-top type display is provided for one or more users. Although interactive displays have increased in size as technology advances, such displays only allow one or more users to interact with a single application that is shown on the interactive display and in focus.

In computing, “focus” indicates the component of the graphical user interface which is selected to receive input. Text entered at the keyboard or pasted from a clipboard is sent to the component which has the focus. Moving the focus away from a specific user interface element is known as a blur event in relation to this element. Typically, the focus is withdrawn from an element by giving another element the focus. This means that focus and blur events typically both occur virtually simultaneously, but in relation to different user interface elements, one that gets the focus and one that gets blurred. For example, when a word processing document and a spreadsheet document are open on a desktop of a computer in a tiled fashion (e.g., next to each other and not overlapping) only one of the documents can have focus. That is, only a single user interface element (e.g., the word processing window or the spreadsheet window) can have focus where it is in a ready state to accept input from the user. The other user interface element is blurred and not in a state to accept input from a user. Thus, when two elements are maintained in focus, both elements are in a state to accept input from one or more users.

On most mainstream user interfaces, such as those provided by the big operating system producers, it is common to find a “focus follows mouse” policy where the focus automatically follows the current placement of the pointer either through a mouse input or a touch input. When a touch occurs, it often is followed by the operating system raising the window that received the input above all other windows on the display. In these types of systems, the current application window continues to retain focus and collect input, even if the mouse pointer is moved over another application window. Another application will not receive focus until it receives an input to transfer focus from one program to another program.

With the advent of ultra-wide aspect ratio multi-sensory input displays, allowing two or more users to collaborate on a single multi-sensory input display while using disparate applications at the same time is desirable. This is especially useful in a classroom or a business setting. For example, in the classroom setting, a teacher could have two students work on a multi-sensory input display where two or more application windows are tiled next to each other where each student works independently on a separate application. That is, each student could work substantially simultaneously (e.g., simultaneously) with each other on the same display with the applications running on the same computer. However, in prior art systems, when one student touches the multi-sensory input display above their respective application front-end window, the input would steal focus from the other student's application. Thus, both students could not substantially simultaneously work in their own application independently of the other without stealing focus away from the other student. Said another way, only a single application can retain focus and be ready to receive input at any one time.

Accordingly, there is a current need for improved systems and methods that allow one or more users to interact substantially simultaneously with a respective application displayed on a single multi-sensory input display without effecting the other user's ability to interact with his respective application—that is without effecting the ability of each user's application to retain focus simultaneously to accept input at the same time or substantially the same time.

### SUMMARY OF THE VARIOUS EMBODIMENTS

In general, in various embodiments, a system that is adapted for allowing multiple users to interact in real-time on an interactive display comprises: (1) a multi-sensory input display; (2) one or more processors coupled to the multi-sensory input display; (3) a user interface that defines a work area having a first portion and a second portion that is mutually exclusive of the first portion; and (4) a first application and a second application running on the one or more processors, where the first application and the second application are configured to be in focus substantially simultaneously with one another. In various embodiments, the system is configured for displaying the work area for the user interface on the multi-sensory input display. The system is also configured for displaying, substantially simultaneously, a first rendering of the first application in the first portion of the work area and a second rendering of the second application in the second portion of the work area. The system is further configured for receiving a first input from a first user on the multi-sensory input display at a first time that corresponds to the first application and receiving a second input from a second user on the multi-sensory input display at a second time that corresponds to the second application. At least partially in response to receiving the first input and the second input, the system is configured for determining, substantially simultaneously, a first change in the first application and a second change in the second application. At least partially in response to determining the first change and the second change, the system is further configured for displaying an updated first rendering of the first application in the first portion of the work area and an updated second rendering of the second application in the second portion of the work area.

In general, in various embodiments, a computer-implemented method for collaborating on a multi-sensory input display executes, on one or more processors, a user interface that is configured to define a work area having a first portion and a second portion. The method also executes a first application and a second application that are both configured to accept input from a user substantially simultaneously with one another. The method displays, by one or more processors, the work area on the multi-sensory input display. The method also creates, by one or more processors, a first rendering of the first application off-screen and a second rendering of the second application off-screen. The method displays, by one or more processors, the first rendering in the first portion of the work area and the second rendering in the second portion of the work area. The method includes receiving at a first time, by the multi-sensory input display, a first input that is associated with the first portion of the work area. The method also includes receiving at a second time, by the multi-sensory input display, a second input that is associated with the second portion of the work area. At least partially in response to receiving the first input, the method determines, by one or more processors, a first change in the first application that corresponds to the first input. At least partially in response to receiving the second input, the method determines, by one or more processors, a second change in the second application that corresponds to the second input. At least partially in response to determining the first change and the second change to the first and second applications, respectively, the method updates, by one or more processors, the first rendering of the first application and the second rendering of the second application to respectively reflect the first and second changes. The method further displays, on the multi-sensory input display, the updated first rendering and the updated second rendering in their respective portions of the work area.

In various embodiments, a system is adapted for allowing two or more users to collaborate in real-time on an interactive display. The system comprises: (1) a multi-sensory input display; (2) one or more processors coupled to the multi-sensory input display; (3) a user interface running on the multi-sensory input display that defines a work area having a first portion and a second portion that is mutually exclusive of the first portion; (4) a first application running on the one or more processors, where the first application is in focus at all times; and (5) a second application running on the one or more processors, where the second application is in focus at all times. The system is configured for displaying the work area for the user interface on the multi-sensory input display. The system is also configured for displaying a first rendering of the first application in the first portion of the work area and a second rendering of the second application in the second portion of the work area. The system is further configured for receiving a first input from a first user on the multi-sensory input display that corresponds to the first application. The system is also configured for receiving a second input from a second user on the multi-sensory input display that corresponds to the second application. At least partially in response to receiving the first input and the second input, the system is configured for determining a first change in the first application and a second change in the second application. At least partially in response to determining the first change and the second change, the system is further configured for displaying an updated first rendering of the first application in the first portion of the work area and an updated rendering of the second application in the second portion of the work area.

### BRIEF DESCRIPTION OF THE DRAWINGS

Various embodiments of a system and method for creating and displaying a presentation are described below. In the course of this description, reference will be made to the accompanying drawings, which are not necessarily drawn to scale, and wherein:

FIG. 1 is a block diagram of an exemplary multi-focus application collaborative system in accordance with an embodiment of the present system;

FIG. 2 is a schematic diagram of a computer, such as the computer 15 of FIG. 1, that is suitable for use in various embodiments;

FIG. 3 illustrates a multi-sensory input display having a work area displayed thereon in accordance with the system of FIG. 1;

FIG. 4 illustrates a tabletop version of a multi-sensory input display having a work area displayed thereon in accordance with another embodiment of the system of FIG. 1;

FIG. 5 illustrates the multi-sensory input display of FIG. 3 with a rendering of a word processing application displayed in a first portion of the work area and a rendering of a web browser application displayed in a second portion of the work area;

FIG. 6 illustrates a flowchart that generally illustrates the operation of the system of FIG. 1;

FIGS. 7A and 7B illustrate a flowchart that generally illustrates the operation of an alternative embodiment of the system of FIG. 1;

FIG. 8 illustrates a multi-sensory input display with the work area divided into three portions and three renderings of the contents of three instances of a web browser program displayed in a respective portion of the work area.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Like numbers refer to like elements throughout.

### Overview

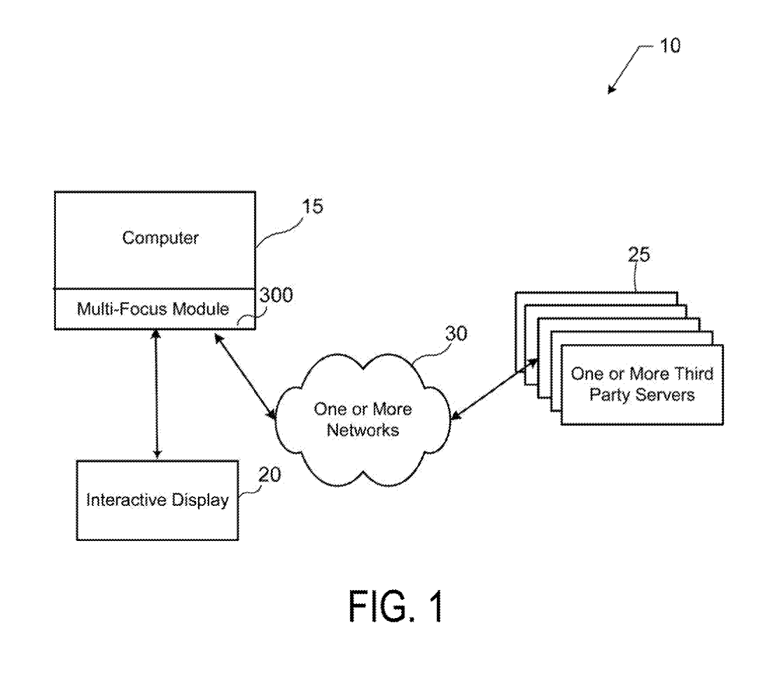

In particular embodiments, a multi-focus application collaborative system 10 (FIG. 1) is configured to allow: (1) two or more applications to be displayed on a multi-sensory input display 20; and (2) one or more users to interact and provide input to the two or more applications at the same time without having to switch focus between the two or more applications. That is, each application retains focus simultaneously so that input from the one or more users is received by the two or more applications without the one or more users having to shift focus from one application to the other in order for each application to receive input from the multi-sensory input display.

### Exemplary Technical Platforms

As will be appreciated by one skilled in the relevant field, the present systems and methods may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagram and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus to produce a machine. As such, the instructions which execute on the general purpose computer, special purpose computer, or other programmable data processing apparatus can direct a computer or other programmable data processing apparatus to function in a particular manner such that the instructions stored in the computer-readable memory produce an article of manufacture that is configured for implementing the functions specified in the flowchart block or blocks.

The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including: a local area network (LAN); a wide area network (WAN); a cellular network; or the connection may be made to an external computer (for example, through the Internet using an Internet Service Provider). These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Example System Architecture

FIG. 1 is a block diagram of a multi-focus application collaborative system 10 according to particular embodiments. As may be understood from this figure, the system 10 includes one or more networks 30. The one or more networks 30 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers), a local area network (LAN), a wide area network (WAN), a cellular network, and/or the connection may be made to an external computer (for example, through the Internet using an Internet Service Provider).

The one or more networks 30 may be operatively connected to a computer 15 (e.g., a laptop, a tablet, a smartphone, a desktop computer, a wearable computing device, etc.), one or more third party servers 25, and a multi-sensory input display 20 (e.g., a touch enabled display, an interactive whiteboard, a touch enabled device (e.g., an infrared emitter and camera, etc.) overlaid on a wall, a horizontal table touch enabled display or any other suitable display that can accept input via one or more of a mouse, a keyboard, a pointer, a pen, gestures, etc.). For purposes of this application the term multi-sensory input display does not mean that one particular display must be capable of receiving input in multiple ways (e.g., touch, voice, movement), instead, a multi-sensory input display is a display that may be enabled to receive input in one or more different manners (e.g., via touch, pen, mouse, movement, voice, etc.). Thus, the term multi-sensory input device should be interpreted broadly. In particular embodiments, the one or more computer networks 30 facilitate communication between the computer 15, the one or more third-party servers 25, and any other remote computing device.

As noted above, the computer 15 may be any suitable computing device. In particular embodiments, the computer 15 is a desktop or laptop computer. In various embodiments, the computer 15 is operatively connected to the multi-sensory input display 20 by a universal serial bus (USB), Wi-Fi, Bluetooth, or any other suitable wired or wireless connection. In particular embodiments, the multi-sensory input display 20 may be used as the computer (e.g., the interactive display has a computer system built directly into the display) thus allowing one or more programs (e.g., an operating system, applications, etc.) to run directly on the multi-sensory input display. In various embodiments, a single computer 15 is used to driver the multi-sensory input display 20. However, the computer 15 may contain one or more processors.

Multi-Sensory Input Display

The multi-sensory input display 20 may be any suitable display device with input/output capabilities. In a particular embodiment, the multi-sensory input display 20 is an interactive whiteboard that is touch, pen, keyboard, mouse, pointer and/or gesture input enabled such as those produced by Promethean World Plc (Promethean Ltd.). An example of an interactive whiteboard is described in U.S. Pat. No. 8,325,162 to Promethean Ltd., which is incorporated by reference herein in its entirety. It should be understood, in light of this disclosure, that the multi-sensory input display 20, in one or more embodiments, is an interactive display other than a whiteboard, such as a computer monitor (which may or may not be touch-enabled), a touch screen computer, an interactive table display, a projector with one or more input sensors, a television operatively connected to one or more motion sensing devices, etc.

Exemplary Computer for Use in the System

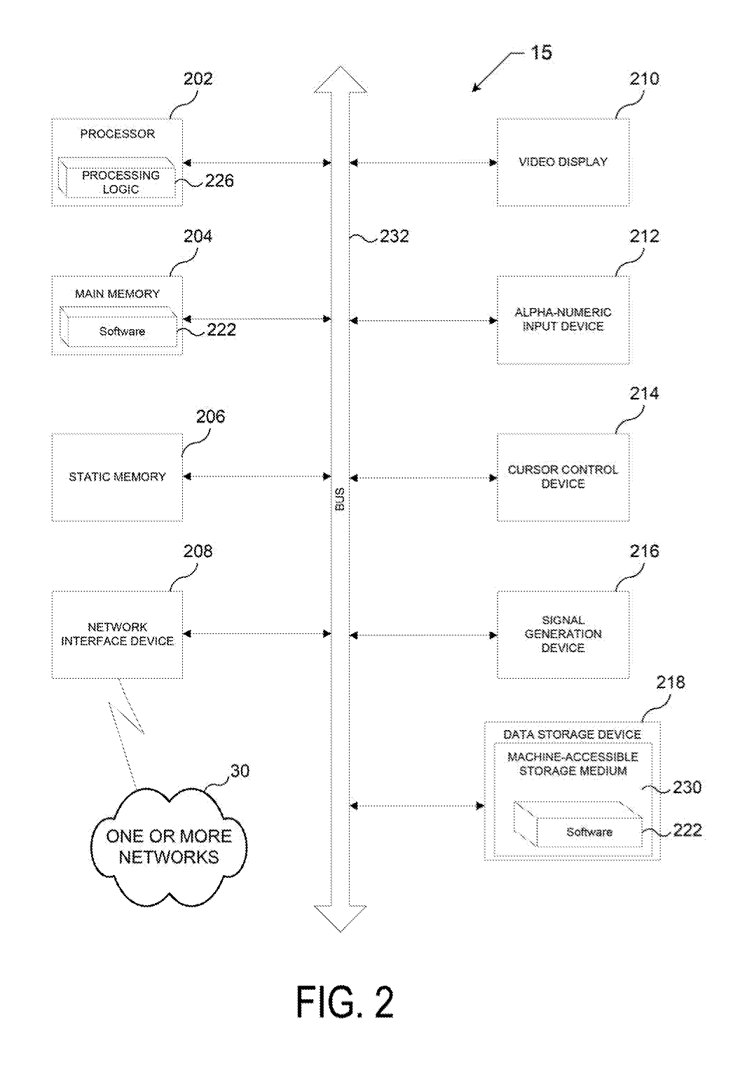

Referring to FIG. 2, below is a more detailed discussion of a computing device that may be used, for example, within the system 10 as a suitable computer 15. However, it should be understood that similar computing devices may be used as one or more of the system's other computer components.

In particular embodiments, the computer 15 may be connected (e.g., networked) to one or more other computers via a LAN, an intranet, an extranet, and/or the Internet. As noted above, the computer 15 may operate in the capacity of a server, a client computer in a client-server network environment, and/or as a peer computer in a peer-to-peer (or distributed) network environment. The computer 15 may be a desktop personal computer (PC), a tablet PC, a set-top box (STB), a Personal Digital Assistant (PDA), a cellular telephone, a web appliance, smart TV, an interactive whiteboard, a server, a network router, a switch or bridge, or any other computer capable of executing a set of instructions (sequential or otherwise) that specify actions to be taken by that computer. Further, while only a single computer is illustrated, the term “computer” should also be understood to include any collection of computers that individually or jointly execute a set (or multiple sets) of instructions to perform any one or more of the methodologies discussed herein.

An exemplary computer 15 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processor 202 represents one or more general-purpose processors such as a microprocessor, a central processing unit, or the like. More particularly, the processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processor 202 may also be one or more special-purpose processors such as an application specific integrated circuit (ASIC), a field programmable gate array (FPGA), a digital signal processor (DSP), network processor, or the like. The processor 202 may be configured to execute processing logic 226 for performing various operations and steps discussed herein.

The computer 15 may further include a network interface device 208. The computer 15 may also include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a machine-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processor 202 during execution thereof by the computer 15—the main memory 204 and the processor 202 also constituting computer-accessible storage media. The software 222 may further be transmitted or received over a network 30 via a network interface device 208.

The software 222 may represent any number of program modules, including, but not limited to an operating system (not shown), one or more applications (not shown), a multi-focus application collaboration module 600, and/or an alternative multi-focus application collaboration module 700. It should be understood that these modules are merely exemplary and may represent a number of program modules that control certain aspects of the operation of the computer 15 (or other system computers, or other computers outside the system). Various embodiments of multi-focus modules are discussed in further detail below.

While the machine-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium (transitory or non-transitory) that is capable of storing, encoding or carrying a set of instructions for execution by the computer and that cause the computer to perform any one or more of the methodologies of the present system. The term “computer-accessible storage medium” should accordingly be understood to include, but not be limited to, solid-state memories, optical and magnetic media, etc.

User Interface

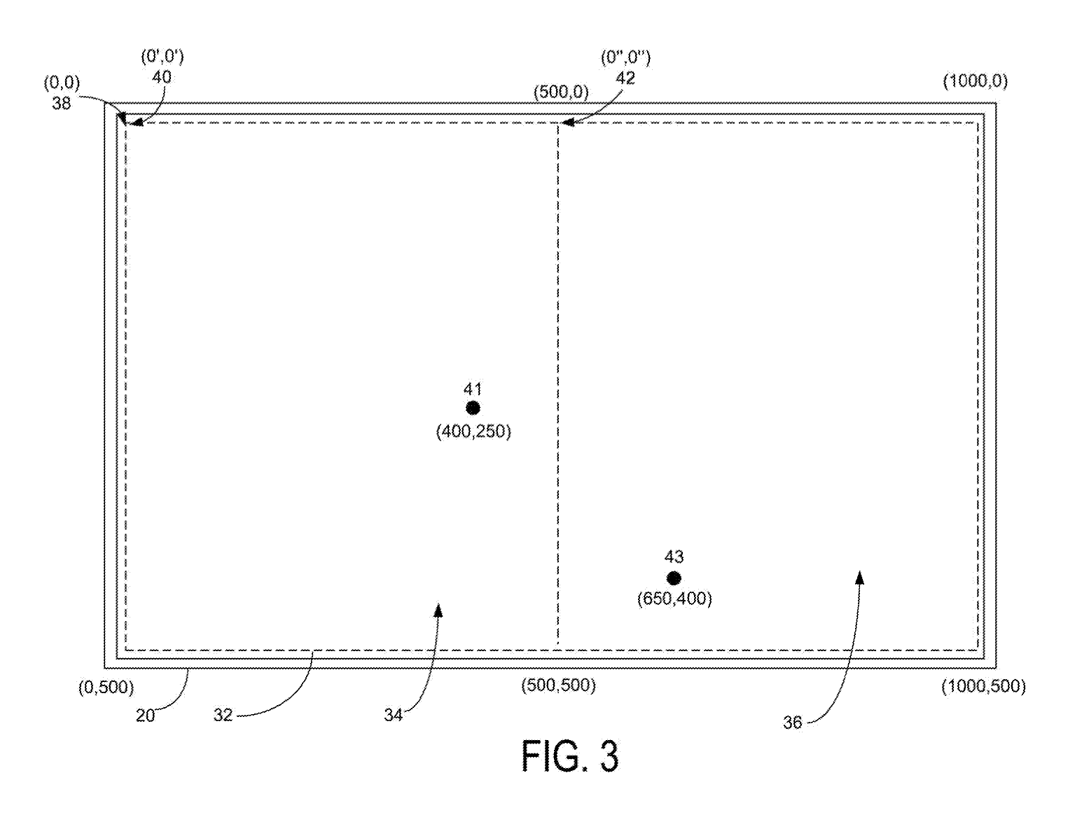

Referring to FIG. 3, in preferred embodiments, a user interface that defines a work area 32 is displayed on the multi-sensory input display 20. The work area 32 may be split into multiple portions 34, 36 where each portion displays a rendering of the contents for a respective application. Thus, each portion is mutually exclusive of any other portion. A world coordinate system 38 is associated with the overall work area having an origin at (0,0). In preferred embodiments, the upper left corner of the work area is designated as (0,0). Each portion 34, 36 of the work area has its own coordinate system associated with it. Thus, when an input is detected by the multi-sensory input display 20, the user interface determines the world coordinates associated with the input. At least partially in response to determining the world coordinates, the user interface next determines which portion of the work area is associated with the input. At least partially in response to determining which portion of the work area is associated with the input, the user interface next transforms the world coordinates for the input into local coordinates associated with the determined portion of the work area. The coordinates are then sent by the user interface to an application associated with the portion of the work area and described in more detail below.

For example and still referring to FIG. 3, the origin (0′,0′) of the first portion 34 of the work area is designated at 40 and the origin (0″,0″) of the second portion 36 of the work area is designated at 42. It should be understood that the number of portions of the work area can range from one to multiple portions depending on the size of the multi-sensory input display 20. Thus, in some embodiments, the work area 32 may be broken into three portions. In other embodiments, the work area 32 may be broken into four portions. In still other embodiments, the work area may be broken into five portions, and so on. It should be understood that when working on a vertically mounted multi-sensory input display, the portions are distributed horizontally to allow multiple users to stand adjacent the display next to one another.

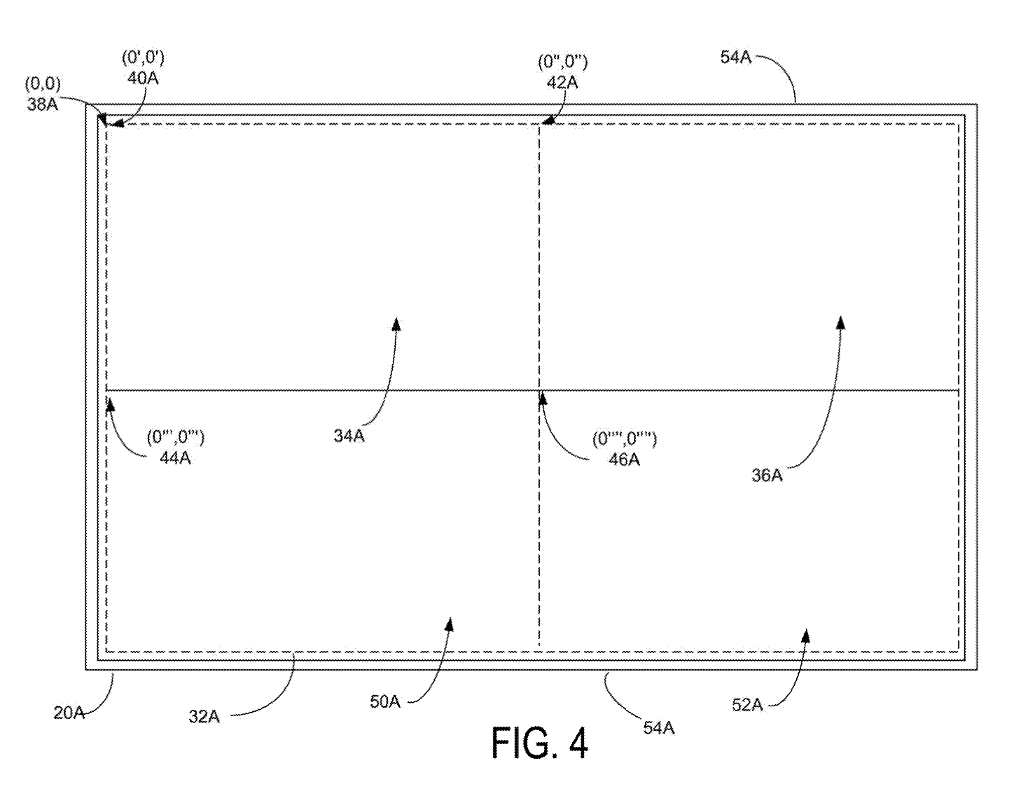

Referring to FIG. 4, in embodiments where the multi-sensory input display is a table top display 20A, the portions 34A, 36A, 50A, and 52A of the work area 32A may be orientated two across the top (34A and 36A) and two across the bottom (50A and 52A) as shown. In such embodiments, the origin (0,0) of the world coordinate system for the work area is designated at 38A. The origin (0′,0′) for the first portion 34A is designated at 40A, the origin (0″,0″) for the second portion 36A is designated at 42A, the origin (0′″,0′″) for the third portion 50A is designated at 44A, and the origin (0″″,0″″) for the fourth portion 52A is designated at 46A. It should also be understood that each portion of the work area can be rotated, as discussed in greater detail below. For example, in the case of a horizontal table, two users may sit along the bottom side 54A of the table and two other users may sit along the top side 56A of the table.

In preferred embodiments, the work area 32 for the user interface is sized to fit the interactive surface of the multi-sensory input display 20. However, it should be understood that this is not a necessity of the system. That is, in some embodiments, the size of the work area 32 may be smaller than the overall size of the interactive area of the multi-sensory input display 20.

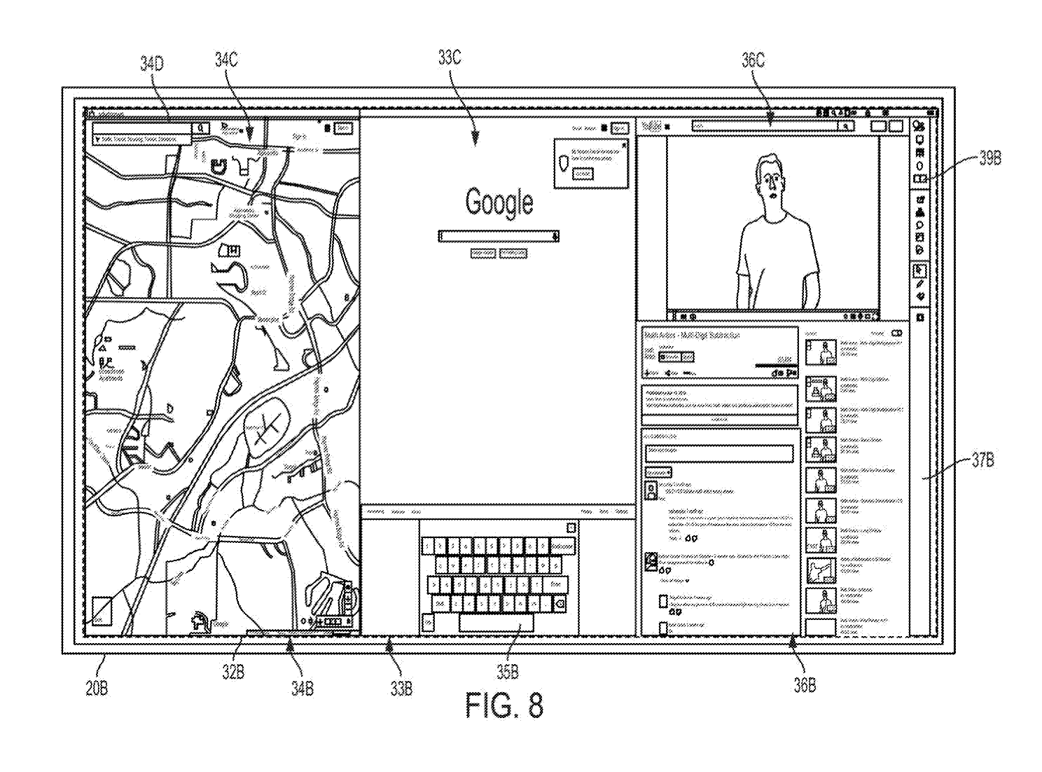

In various embodiments, the user interface may include a menu bar 37B (seen in FIG. 8) that allows the user to set the number of portions of the work area that are displayed on the multi-sensory input display 20. For example, the user interface may split the work area into one or more portions (e.g., two portions, three portions, four portions, etc.) depending on how large the multi-sensory input display is and on the amount of space each application requires in its respective portion of the work area. In preferred embodiments, the size of each portion of the work area is the same (e.g., uniform in size). In other embodiments, the size of each portion of the work area may be different depending on the needs of the application. The only requirement of the system is that each portion of the work area be mutually exclusive of any other portion of the work area. In some embodiments, the menu bar may also include a menu item 39B (FIG. 8) that allow a user to select each application to be opened in a respective portion of the work area.

First and Second Applications

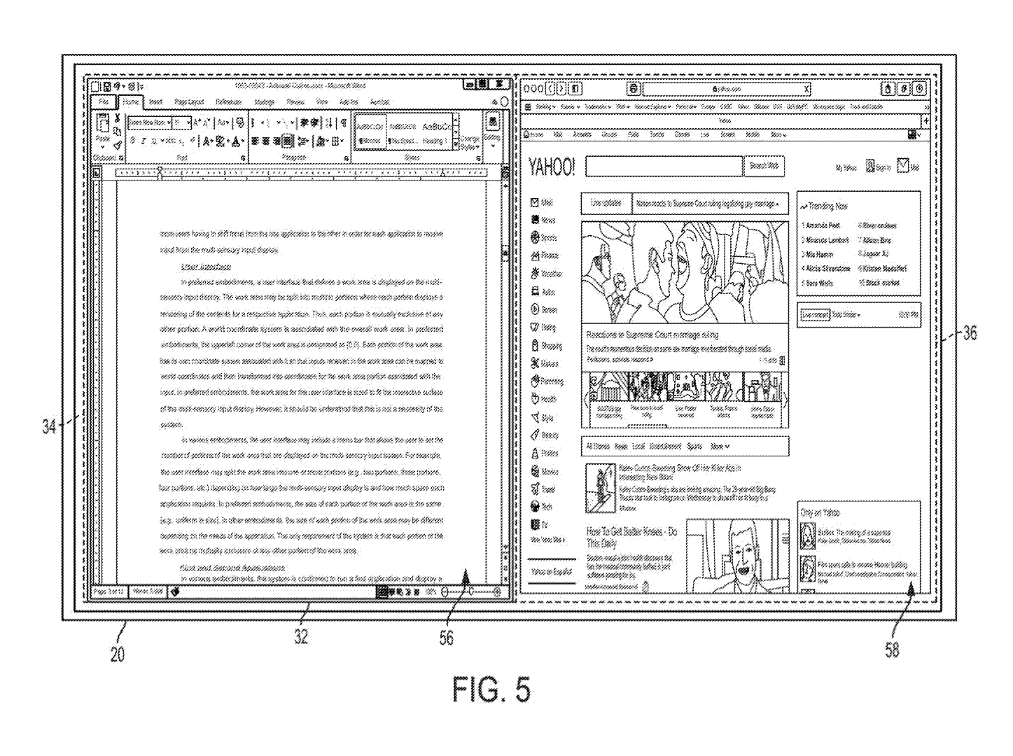

Referring to FIG. 5, in various embodiments, the system is configured to run a first application (e.g., a word processor application, a presentation application, a spreadsheet application, a web browser application, etc.) and display a first rendering 56 of the content for the first application in the first portion 34 of the work area 32 associated with the first application. Moreover, the system is also configured to run a second application (e.g., a word processor application, a presentation application, a spreadsheet application, a web browser application, etc.) and display a second rendering 58 of the content for the second application in the second portion 36 of the work area 32 associated with the second application. As discussed above, the first portion 34 is mutually exclusive from the second portion 36. In this way, the first rendering 56 of the contents of the first application and the second rendering 58 of the contents of the second application are displayed in a tiled format on the multi-sensory input display 20.

In various embodiments, the rendering of the contents of the first and second applications occurs on-screen (e.g., displayed directly on the multi-sensory input display 20). In other embodiments, the rendering of the contents of the first and second applications occurs off-screen (e.g., in memory, video buffer, etc.). In these embodiments, the first and second applications send an image of the rendering to the user interface to be displayed in the respective portion 34 or 36 of the work area 32. In the latter case the image can be sent automatically by the application each time a change in the contents occurs, or the image can be sent in response to a call from the user interface to the applications.

In various embodiments, the first and second applications can be different instances of the same application. For example, the first application can be a first instance of a web browser program and the second application can be a second instance of a web browser program. In this example, each instance of the web browser program would run in the background and a rendering of each instance of the web browser program would occur off-screen (e.g., in memory, video buffer, etc.). Each time the first and second instance of the web browser program detected a change due to input at the multi-sensory input display 20, the instance of the web browser associated with the input would respond to the input, and if the input caused the contents of the web browser to change, the instance of the web browser effected would re-render its contents and send a new image of the rendering to the user interface to be displayed in its respective portion of the work area.

Transforming Input Coordinates from World Coordinates to Local Coordinates

Inputs received by the multi-sensory input display 20 are passed to the user interface in order to convert world coordinates of the input into local coordinates for the portion of the work area associated with the input. That is, in this example where the work area is split into two portions—the first portion and the second portion—the user interface transforms the world coordinates of the input into either a first coordinate system associated with the first portion or a second coordinate system associated with the second portion of the work area.

Referring once again to FIG. 3, the following is an example of a transformation that can be used to determine which portion is associated with an input and the local coordinates associated with that input. In this example, the work area 32 has an origin at (0,0) designated at 38, the work area upper right corner has a world coordinate of (1000,0), a lower left corner has a world coordinate of (0,500) and a lower right corner has a world coordinate of (1000,500). Thus, the work area has coordinates that extend from an upper left corner of (0,0) to a lower right corner of (1000,500). Furthermore, the first portion 34 has an upper left corner that extends from the world coordinate (0,0) to a lower right corner that extends to world coordinates (500,500). Additionally, the second portion 36 has an upper left corner that extends from the world coordinate (500,0) to a lower right corner that is located at (1000,500).

Assume that a first input 41 occurs at world coordinates (400,250) for the work area 32. The first step is to check the world coordinates for the first input 41 against the world coordinates for the first portion 34, which extends from world coordinates (0,0) to (500,500) using the following two tests.

First Portion 34:

Test 1: (400,250)−(0,0)=(400,250). The result of the subtraction is not negative.

Test 2: (400,250)≦(500,500)=Yes

Test 1 checks to see if the world coordinates for the first input 41 are greater than the world coordinates for the upper left corner of the first portion 34. The answer to this test is yes so the results of the subtraction are positive. The second test checks to see if the world coordinates for the first input 41 are less than the world coordinates for the bottom right corner of the first portion 34. Once again the test results are positive since the coordinates of the first input 41 (400,250) is less than or equal to the world coordinates (500,500). Thus, the results of the test indicate that the first input 41 occurred in the first portion 34 of the work area 32. Additionally, the local coordinates for the first input 41 in the first portion 34 is (400′,250′), which is the result from the subtraction of the first Test 1. Thus, the use interface can pass the local coordinates (400′,250′) for the first input 41 to the back-end of the first application associated with the first portion 34.

In a second example, assume a second input 43 occurs at world coordinates (650,400) for the work area 32. The first and second tests are applied for the first portion 34 as follows.

First portion 34:

Test 1: (650,400)−(0,0)=(650,400). The result of the subtraction is not negative.

Test 2: (650,400)≦(500,500)=No

Although the result of the first test is positive, the result of the second test is negative. Thus, the system knows that the second input 43 did not occur in the first portion 34. Thus, the two tests are performed again for the second portion 36 as shown below.

Second portion 36:

Test 1: (650,400)−(500,0)=(150,400). The result of the subtraction is not negative.

Test 2: (650,400)≦(1000,500)=Yes

The test 1 results are positive and the results of test 2 are also positive. Thus, the system knows that the second input 43 occurred in the second portion 36. Moreover, the results of test 1 also provide the local coordinates (150″,400″) for the second input 43 in the second portion 36. As a result, the user interface passes the local coordinates (150″,400″) to the back-end of the second application associated with the second portion 36.

The above illustrates preferred embodiments for determining which portion of a multi-portion tiled user interface an input is associated with. Furthermore, the above tests also illustrate preferred methods for performing a transformation to determine the local coordinates of an input for the portion based on the input's world coordinates in the work area. One of skill in the art should understand that other methods exist to determine which portion of multiple portions receives an input and the local coordinates for the input. Thus, the present system should not be limited to the methods described herein.

As discussed above, once the user interface determines the transformed coordinates and which of the first and second portions is associated with the input, the coordinates for the input are passed to the back-end of the instance of the application that is associated with the portion in which the input occurred. Because each instance of the application is always in focus, each instance is always ready to receive input from the system without having to switch focus from one application to another application.

In addition to the above methods for determining the portion to which an input is associated and the local coordinates for the input, the system also has the ability to render the contents of the application in any orientation depending on the use of the system. For example, assuming that the multi-sensory input device 20 is a table top interactive display where multiple users sit on each side of the display, as described above with reference to FIG. 4. In these instances, the renderings of the application must be rotated to accommodate the position of the users. Said another way, the rendering of the application for each portion of the work area for a table top display must be orientated to accommodate the position of the user with respect to the work area.

Referring once again to FIG. 4, if a user is sitting adjacent to the upper side 54A of the table display 20A, then the renderings of the content for the applications displayed in the first portion 34A and the second portion 36A must be rotated 180 degrees from the renderings displayed in the third portion 50A and the fourth portion 52A. As a result, when an input is detected in one of the first portion 34A or the second portion 36A, the coordinates associated with the input must be transformed to take into account the fact that the rendering of the respective application has also been rotated by some number of degrees (e.g., 90 degrees clockwise, 180 degrees, 90 degrees counterclockwise, etc.). Thus, the following code is an exemplary transformation methodology that also takes into account any rotation of the displayed renderings:

portionRect(x, y, width, height) in work area coords
point(x, y) in local tile coords
result(x, y) in local tile coords

if orientation is normal, do nothing
result=point

if orientation is 180 degrees
result.x=portionRect.width−point.x
result.y=portionRect.height−point.y

if orientation is clockwise 90 degrees
result.x=point.y
result.y=portionRect.width−point.x

if orientation is counter clockwise 90 degrees
result.x=point.y
result.y=portionRect.height−point.x

### Alternate Embodiment of the User Interface

In some embodiments, the user interface may be a transparent acetate virtual layer that is positioned in the z-axis over the renderings of the contents of the first and second applications. In various embodiments, the contents of the first and second applications are rendered on-screen and displayed in a tiled format so the displayed renderings do not overlap. The transparent acetate virtual layer is positioned on top of the renderings for the first and second applications so that any input to the multi-sensory input display is received by the transparent acetate virtual layer and not the front-end user interface for either application. Thus, the multi-sensory input display receives the input in world coordinates and then transforms the input into local coordinates for the front-end of the respective associated application. The local coordinates are then sent via the operating system management system via API call to the corresponding application back-end. The application then determines a change in the contents for the application based on the received input and updates the rendering of the contents of the application displayed on the multi-sensory input display.

### Operation of Exemplary Systems

As noted above, a multi-focus application collaborative system 10, according to various embodiments, is adapted to allow multiple users to interact in real-time with one or more applications displayed on a multi-sensory input display. Various aspects of the system's functionality may be executed by certain system modules, including a multi-focus application collaboration module 600, and an alternative multi-focus application collaboration module 700. The multi-focus application collaboration module 600, and alternative multi-focus application collaboration module 700 are discussed in greater detail below.

Multi-Focus Application Collaboration Module

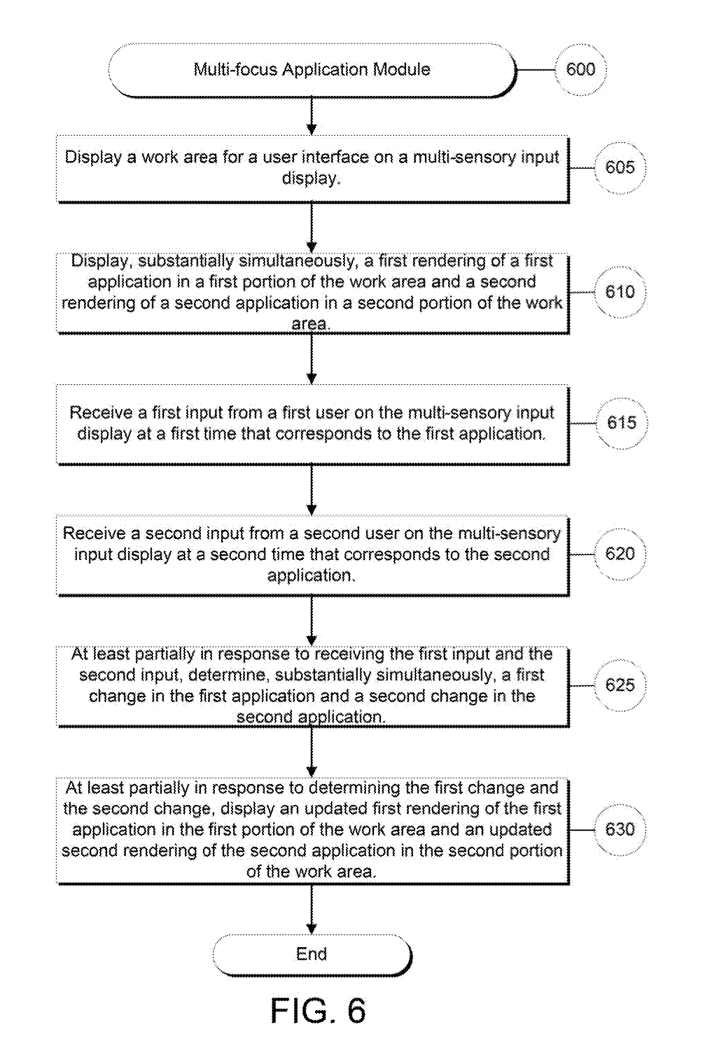

FIG. 6 shows a flowchart of operations performed by a multi-focus application collaboration module 600, which may, for example, run on the computer 15, or any suitable computing device (such as a suitable mobile computing device). In particular embodiments, the multi-focus application collaboration module 600 allows multiple users to interact in real-time with multiple applications being displayed on a single multi-sensory input display.

The system begins at Step 605 by displaying a work area for a user interface on a multi-sensory input display. The work area may comprise a transparent layer that is displayed on the multi-sensory input display 20. In various embodiments, the multi-sensory input display 20 includes any suitable interactive display that can accept at least one of a mouse, touch, pointer, pen or sensory input. In some embodiments, displaying a work area for the user interface on the multi-sensory input display includes projecting the work area onto a surface of the multi-sensory input display by a projector. In other embodiments, displaying a work area for the user interface on the multi-sensory input display comprises displaying graphic data on a touch-enabled display panel. In some embodiments, the multi-sensory input display is a table top display. In various embodiments, the work area is the full surface area of the multi-sensory input display. In other embodiments, the work area only occupies a portion of the full surface area of the multi-sensory input display.

In some embodiments, a world coordinate system is associated with the work area. In various embodiments, the world coordinate system of the work area comprises an X and Y coordinate system. In other embodiments, the world coordinate system of the area comprises an X, Y, and Z coordinate system. In various embodiments, the work area is divided into one or more portions to allow one or more applications to be displayed on a respective portion of the one or more portions of the work area. For example, the work area may be divided to allow a first application to be displayed on a first portion of the work area and a second application to be displayed on a second portion of the work area. In particular embodiments, the second portion of the work area is mutually exclusive of the first portion of the work area.

At Step 610, the system displays, substantially simultaneously, a first rendering of the contents of a first application in the first portion of the work area and a second rendering of the contents of a second application in the second portion of the work area. In various embodiments, the first application and the second application are in focus substantially simultaneously (e.g., simultaneously) substantially continuously (e.g., all the time). For example, when the system receives a second input for the second application after receiving a first input for the first application, the second input does not cause the first application to go out of focus or become blurry (e.g., not in a state to receive input).

In various embodiments, the first application and the second application may be any suitable computer application (e.g., web browser application, spreadsheet application, word processing application, drawing application, presentation application, etc.). In particular embodiments, the first application and the second application include any one or more editable fields. In various embodiments, the first application and the second application include a first and a second instance of the same application. For example, the first application may be a first instance of a web browser program and the second application may be a second instance of a web browser program. In particular embodiments, the first application and the second application are instances of different applications. For example, the first application may be an instance of a word processing program and the second application may be an instance of a spreadsheet program. Thus, it should be understood that the first application may be any instance of any first program and the second application may be any instance of any second program. In particular embodiments, the first application is a first instance of a web browser application and the second application is a second instance of a web browser application. In some embodiments, the first application is a first instance of a web browser and the second application is a first instance of a spreadsheet application. In particular embodiments, the first application is a first instance of a drawing application and the second application is a first instance of a presentation application.

In various embodiments, the first rendering and the second rendering may occur off-screen and may include any suitable computer output file stored to memory or video buffer. In particular embodiments, the first rendering and the second rendering may include an image of a rendering of the contents of the first or second application. In some embodiments, the first rendering and the second rendering may include a series of images (e.g., frames) saved individually or sequenced into video format.

In various embodiments, the first rendering and the second rendering may be displayed in any suitable orientation. For example, on a table top display, the first rendering of the first application on the first portion of the work area of the multi-sensory input display may be rotated 180-degrees from the second rendering of the second application on the second portion of the work area of the multi-sensory input display so that a first user can sit on a first side of the table top display and a second user can sit on a second side of the table top display that is opposite the first side. In some embodiments, where the multi-sensory input display is a display mounted vertically on a stand or the wall, the first portion, second portion and any other portions are orientated in a tiled format one next to the other so that one or more users can stand adjacent the display next to each other.

Continuing at Step 615, the system receives a first input from a first user on the multi-sensory input display at a first time that corresponds to the first application and receives a second input from a second user on the multi-sensory input display at a second time that corresponds to the second application. In various embodiments, the first input and the second input may be any suitable type of input (e.g., touch, pen, pointer, gesture, etc.). In particular embodiments, the first input and the second input may be the same type of input. For example, the first user and the second user may use touch input on the multi-sensory input display. In some embodiments, the first input and the second input may be different types of input. For example, the first user may use pen input and the second user may use touch input on the multi-sensory input display. In various embodiments, the first input may be a touch and hold input (e.g., a user touches the multi-sensory input display and moves the touch input without removing it from the surface of the multi-sensory input display) and the second input may be a single touch input (e.g., a user touches the multi-sensory input display and immediately removes the touch input from the multi-sensory input display). In some embodiments, the first input and the second input may both be a touch and hold type input. In particular embodiments, the first input and the second input may both be a single touch input.

In various embodiments, the first time that corresponds to when the system receives the first input and the second time that corresponds to when the system receives the second input occur substantially simultaneously (e.g., simultaneously or within a few milliseconds of each other). In some embodiments, the first time and the second time occur at different times. In particular embodiments, the first time begins before the second time begins and ends after the second time ends. In various embodiments, the first time begins and ends before the second time begins.

In some embodiments, the system receives the first input in a first editable field for the first application. In particular embodiments, the system receives the second input in a second editable field for the second application. In various embodiments, at least partially in response to receiving the first input in the first editable field, the system displays a first on-screen keyboard in the first portion of the work area. In some embodiments, at least partially in response to receiving the second input in the second editable field, the system displays a second on-screen keyboard in the second portion of the work area. In particular embodiments, the first on-screen keyboard and the second on-screen keyboard are displayed substantially simultaneously (e.g., simultaneously) in its respective portion of the work area. In various embodiments, the first on-screen keyboard and the second on-screen keyboard are configured to receive input substantially simultaneously (e.g., simultaneously).

In particular embodiments, the system receives the first input and the second input at the multi-sensory input device, which transmits the world coordinates of the inputs to the user interface. In various embodiments, the user interface transmits the first input coordinates via an operating system API to the back-end of the first application and transmits the second input coordinates via an operating system API to the back-end of the second application. In particular embodiments, the operating system may be any suitable operating system (e.g., IOS, Mac OS X, Android, Linux, Windows, etc.).

In various embodiments, when the system receives the first input from the first user, the following steps may occur: (1) the system detects a first input on the multi-sensory input display; (2) at least partially in response to detecting the first input, the system determines a first set of coordinates associated with the first input based on a world coordinate system associated with the work area; (3) the system determines whether the first set of coordinates is associated with the first portion of the work area or the second portion of the work area; (4) at least partially in response to determining whether the first set of coordinates is associated with the first portion or the second portion, the system converts the first set of coordinates into a second set of coordinates associated with one of a first coordinate system associated with the first portion and a second coordinate system associated with the second portion; and (5) the system transmits the second set of coordinates to the application associated with the one of the first coordinate system and the second coordinate system. In particular embodiments, the system may perform substantially the same steps when the system receives the second input from the second user.

At Step 620, at least partially in response to receiving the first input and the second input, the system determines, substantially simultaneously, a first change in the first application and a second change in the second application. In various embodiments, the first change and the second change may include no change. In particular embodiments, the first change and the second change may be any suitable change allowed by any computer application. In various embodiments, the first change and the second change may include a refresh of the first and second application. In some embodiments, the first change and the second change may be a scrolling of the application. In various embodiments, the first change and the second change may include an input into an editable field.

At Step 625, at least partially in response to determining the first change and the second change, the system displays an updated first rendering of the first application in the first portion of the work area and an updated second rendering of the second application in the second portion of the work area. In various embodiments, the system displays the updated first rendering and the updated second rendering substantially immediately (e.g., immediately) in response to determining the first change and the second change. For example, although the system transmits the first input and the second input via an operating system API to the back-end of the first application and the second application, respectively, and therefore there is inherent lag, to a user it would appear as if no lag occurred and changes made to the first and second applications would immediately appear on the multi-sensory input display. In particular embodiments, the updated first rendering and the updated second rendering may include an image. In some embodiments, the updated first rendering and the updated second rendering may include a series of images (e.g., frames) saved individually or sequenced into video format and stored in memory, video buffer, etc.

Alternative Multi-Focus Application Collaboration Module

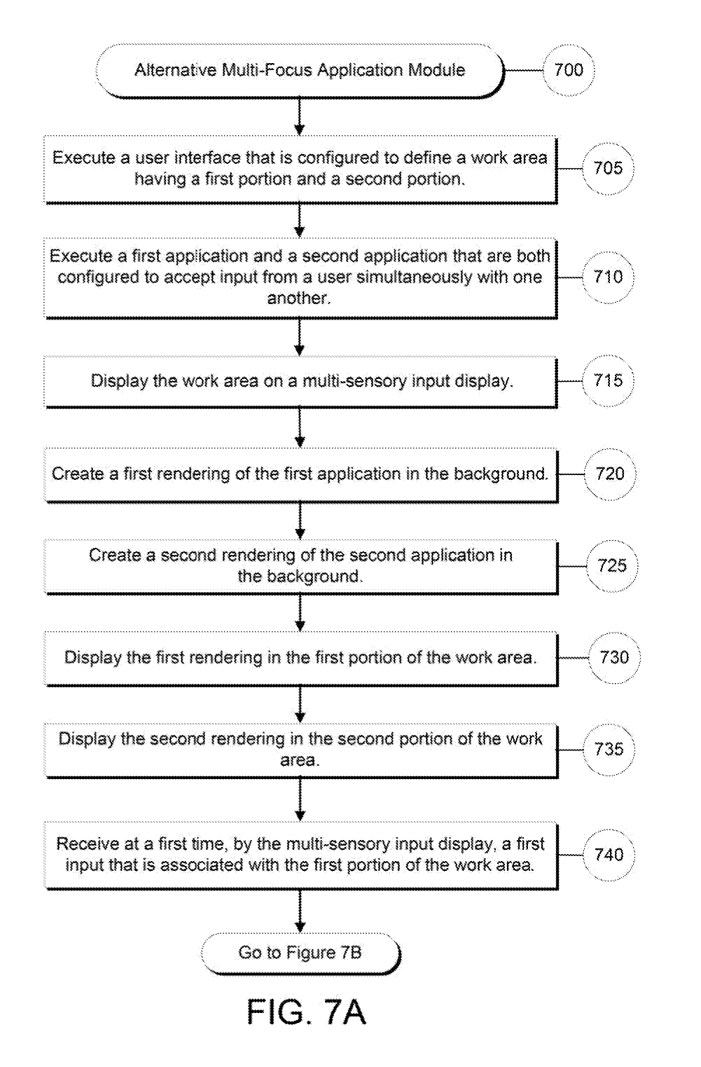

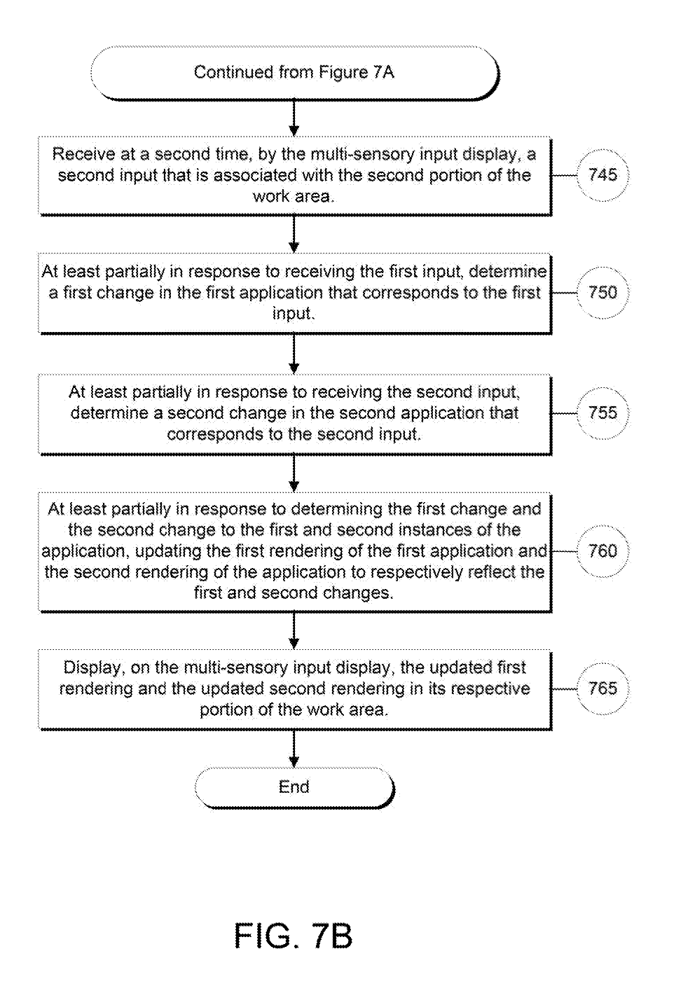

FIGS. 7A and 7B illustrate a flowchart of operations performed by an alternative multi-focus application collaboration module 700, which may, for example, run on the computer 15, or any suitable computing device (such as a suitable mobile computing device). In particular embodiments, the alternate multi-focus application collaboration module 700 allows for collaborating on a multi-sensory input display by rendering the contents of one or more applications either on-screen or off screen.

The system begins at Step 705 by executing, on one or more processors, a user interface that is configured to define a work area having a first portion and a second portion. In various embodiments, the user interface of the multi-sensory input display includes any suitable interactive display. In some embodiments, the work area is the full surface area of the multi-sensory input display. In particular embodiments, the work area is a portion of the full surface area of the multi-sensory input display. In some embodiments, the first portion and the second portion of the work area are the same size. In other embodiments, the first portion and the second portion of the work area are different sizes. In particular embodiments, the first portion is larger than the second portion. In various embodiments, the first portion may be positioned in any position near the second portion (e.g., beside the second portion, on top of the second portion, under the second portion, around the second portion, inside of the second portion, etc.). In particular embodiments, the first portion and the second portion may be oriented in any orientation (e.g., between zero and 180-degrees). For example, the first portion may be rotated 180-degrees from the second portion. In various embodiments, the work area is divided into more than two portions.

In various embodiments, a world coordinate system is associated with the work area. In various embodiments, the world coordinate system of the multi-sensory input display is graphed on an X and Y coordinate system. In other embodiments, the world coordinate system of the multi-sensory input display is graphed on an X, Y, and Z coordinate system.

At Step 710, the system continues by executing a first application and a second application that are both configured to accept input from a user simultaneously with one another. In various embodiments, the first application and the second application are in focus substantially simultaneously (e.g., simultaneously) substantially continuously (e.g., all the time). For example, when the second application receives input after the first application receives input, the input received by the second application does not cause the first application to go out of focus or become blurry. In various embodiments, the first application and the second application may be any suitable computer application (e.g., web browser application, spreadsheet application, word processing application, drawing application, presentation application, etc.). In particular embodiments, the first application and the second application include any one or more editable fields. In various embodiments, the first application and the second application include a first and a second instance of the same application. In particular embodiments, the first application and the second application are instances of different applications.

In particular embodiments, the first application is a first instance of a web browser application and the second application is a second instance of a web browser application. In some embodiments, the first application is a first instance of a web browser and the second application is a first instance of a spreadsheet application. In particular embodiments, the first application is a first instance of a drawing application and the second application is a first instance of a presentation application. In some embodiments, the first application is a first instance of an application running in the background and the second application is a second instance of the application running in the background. In various embodiments, the first application is an instance of a web browser application running in the background and the second application is a presentation application also running in the background.

In particular embodiments, the first application receives a first input from a first user and the second application receives a second input from a second user. In various embodiments, the first and second inputs are received from the same user. In some embodiments, the first input and the second input may be any suitable type of input (e.g., touch, pen, pointer, gesture, etc.). In particular embodiments, the first input and the second input may be the same type of input. For example, the first input and the second input may be touch input on the multi-sensory input display. In some embodiments, the first input and the second input may be different types of input. For example, the first user may use pen input and the second user may use touch input on the multi-sensory input display. In various embodiments, the first input may be a touch and hold input (e.g., a user touches the multi-sensory input display and moves the touch input without removing it from the multi-sensory input display) and the second input may be a single touch input (e.g., a user touches the multi-sensory input display and immediately removes the touch input from the multi-sensory input display). In some embodiments, the first input and the second input may both be a touch and hold input. In particular embodiments, the first input and the second input may both be a single touch input.

Continuing to Step 715, the system displays, by one or more processors, the work area on the multi-sensory input display. In various embodiments, system displays the work area on the multi-sensory input display by sending information to an interactive display. In some embodiments, displaying a work area on the multi-sensory input display includes projecting the work area onto a surface of the multi-sensory input display by a projector. In other embodiments, displaying a work area on the multi-sensory input display includes sending graphic data to a touch-enabled television.

At Steps 720 and 725, the system creates, either on-screen or off-screen, by one or more processors, a first rendering of the first application and a second rendering of the second application. In particular embodiments, the system creates the first and second renderings substantially immediately in response to the application being opened. In various embodiments, the first and second renderings are created on-screen. In some embodiments, the first and second renderings are created off-screen. In various embodiments, the first rendering and the second rendering may include any suitable computer output file and stored in memory, video buffer, etc. In particular embodiments, the first rendering and the second rendering may include an image. For example, the first rendering and the second rendering are performed off screen and the application sends a snapshot of the rendering to be displayed in the work area. In some embodiments, the first rendering and the second rendering may include a series of images (e.g., frames) saved individually or sequenced into video format.

The system, at Steps 730 and 735, displays, by one or more processors, the first rendering in the first portion of the work area and the second rendering in the second portion of the work area. In various embodiments, the first rendering and the second rendering may be displayed in any suitable orientation. For example, on a table top display, the first rendering of the first application on the first portion of the work area of the multi-sensory input display may be rotated 180-degrees from the second rendering of the second application on the second portion of the work area of the multi-sensory input display so that a first user can sit on a first side of the table top display and a second user can sit on a second side of the table top display that is opposite the first side. In various embodiments, displaying the first rendering in the first portion of the work area further includes displaying a first image of the first rendering in the first portion of the work area. In some embodiments, displaying the second rendering in the second portion of the work area further includes displaying a second image of the second rendering in the second portion of the work area.

At Steps 740 and 745, the system receives, by the multi-sensory input display, at a first time, a first input that is associated with the first portion of the work area and at a second time, a second input that is associated with the second portion of the work area. In various embodiments, the first time is a first time period with a first beginning time and a first end time. In particular embodiments, the second time is a second time period with a second beginning time and a second end time. In some embodiments, the second time occurs after the first beginning time and before the first end time of the first time period. In particular embodiments, the first time that corresponds to when the system receives the first input and the second time that corresponds to when the system receives the second input occur substantially simultaneously (e.g., simultaneously or within a few milliseconds of each other). In various embodiments, the second time is substantially the same as the first time. In some embodiments, the first time and the second time occur at different times. In particular embodiments, the first time begins before the second time begins and ends after the second time ends. In various embodiments, the first time begins and ends before the second time begins.

At Steps 750 and 755, at least partially in response to receiving the first input and the second input, the system determines, by one or more processors, a first change in the first application that corresponds to the first input and a second change in the second application that corresponds to the second input. In various embodiments, the first change and the second change may include no change. In particular embodiments, the first change and the second change may be any suitable change allowed by any computer application. In various embodiments, the first change and the second change may include a refresh of the first and second application. In some embodiments, the first change and the second change may be a scrolling of the application. In various embodiments, the first change and the second change may include an input into an editable field.

At Step 760, at least partially in response to determining the first change and the second change to the first and second instances of the application, the system updates, by one or more processors, the first rendering of the first application and the second rendering of the second application to respectively reflect the first and second changes. In various embodiments, the system updates the first rendering and the second rendering on-screen on the multi-sensory input display. In other embodiments, the system updates the first rendering and the second rendering off-screen. In some of these embodiments, the system updates the first rendering and the second rendering in the background. In particular embodiments, the system updates the first rendering and the second rendering substantially automatically in response to determining the first change and the second change. In some embodiments, the system updates the first rendering and the second rendering substantially simultaneously. For example, the system maintains simultaneous focus in the first application and the second application to update the first and second renderings.

Continuing to Step 765, the system displays, on the multi-sensory input display, the updated first rendering and the updated second rendering in their respective portions of the work area. In various embodiments, the system displays the updated first rendering and the updated second rendering substantially immediately (e.g., immediately) in response to receiving the updated renderings reflecting the first and second changes. For example, in embodiments where the system creates the first and second renderings in the background, and therefore there is inherent lag, to a user it would appear as if no lag occurred and changes in the respective applications would immediately appear on the multi-sensory input display. In particular embodiments, the updated first rendering and the updated second rendering may include an image. For example, when the system renders the contents of the first and second applications off-screen, each application may send a snapshot of the rendering to the user interface to be displayed on the work area. In some embodiments, the updated first rendering and the updated second rendering may include a series of images (e.g., frames) saved individually or sequenced into video format.

In various embodiments where images of the rendered content for each application is displayed, displaying the updated first rendering and the updated second rendering in its respective portion of the work area further includes displaying a third image of the updated first rendering in the first portion of the work area and displaying a fourth image of the updated second rendering in the second portion of the work area. In some embodiments, one of the first image and the third image and another of the second and the fourth image are displayed substantially simultaneously on the multi-sensory input display.

### Exemplary User Experience

Referring to FIG. 8, an teacher or business person may set up the multi-focus application system 10 so that the multi-sensory input display 20B displays a work area 32B having three portions 34B, 35B and 36B. The user interface also displays a menu bar 37B that contains one or more menu items, including a menu item 39B that allows the user to set the number of portions of the work area to be defined on the multi-sensory input display 20B. In the present example, the person has selected three instances of a web browser program to be rendered to a respective work area portion. In particular, the first portion 34B displays a first instance 34C of a web browser program that renders the contents of a map. The second portion 33B of the work area displays a second instance 33C of a web browser program that renders the contents of a Google® search page. Finally, the third portion 36B of the work area displays a third instance 36C of a web browser that renders the contents of a YouTube® page. Each instance of the web browser program is active and in focus such that three separate users may interact with a respective instance of the web browser program simultaneously or substantially simultaneously without shifting focus between the various instances of the web browser application.

For example, a first user may zoom into the map while a second user types text input into the editable field 33D using the on-screen keyboard 35B. Finally, substantially simultaneously, a third user may select a video to view on the third instance 36C of the web browser program. The input for each display rendering may be received simultaneously (e.g., three distinct inputs are received at the same time on each separate rendering) or substantially simultaneously (e.g., a first input begins at time T₀ and ends at time T₉, a second input starts at time T₂ and ends at time T₈ and a third input starts at time T₁₁ and ends at time T₁₂ or a first input starts at time T₀ and ends at time T₅, a second input starts and ends at time T₇ and a third input starts and ends at time T₉). In either case, when an first input is received by one instance of the web browser program and a second input is received by a second instance of the web browser program, focus does not shift from the instance of the web browser program that received the first input to the instance of the web browser program that received the second input. Instead, both programs are in focus. That is, focus never shifts between instances of the web browser program since all three instances are always in focus and ready to receive input from the multi-sensory input display 20B.

### CONCLUSION

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A system for allowing multiple users to interact in real-time on an interactive display comprising:
a. a multi-sensory input display;
b. one or more processors coupled to the multi-sensory input display;
c. a user interface running on the multi-sensory input display that defines a work area having a first portion and a second portion that is mutually exclusive of the first portion; and
d. a first application and a second application running on the one or more processors, wherein the first application and the second application are configured to be in focus substantially simultaneously with one another;
wherein the system is configured for:
i. displaying the work area for the user interface on the multi-sensory input display;
ii. displaying, substantially simultaneously, a first rendering of the first application in the first portion of the work area and a second rendering of the second application in the second portion of the work area;
iii. receiving a first input from a first user on the multi-sensory input display at a first time that corresponds to the first application;
iv. receiving a second input on the multi-sensory input display at a second time that corresponds to the second application;
v. at least partially in response to receiving the first input and the second input, determining, substantially simultaneously, a first change in the first application and a second change in the second application; and
vi. at least partially in response to determining the first change and the second change, displaying, an updated first rendering of the first application in the first portion of the work area and an updated second rendering of the second application in the second portion of the work area.

2. The system of claim 1, wherein the second input is received from a second user.

3. The system of claim 1, wherein the user interface is a transparent virtual layer that is positioned over the rendering of the first application and the second application, wherein the system is further configured for:
a. receiving the first input by the transparent layer; and
b. transmitting the first input via an operating system API to the back-end of the first application.

4. The system of claim 1, wherein the step of displaying a work area for the user interface on the multi-sensory input display further comprises projecting the work area onto a surface of the multi-sensory input display by a projector.

5. The system of claim 1, wherein the step of receiving a first input from a first user on the multi-sensory input display that corresponds to the first application further comprises:
a. detecting a first input on the multi-sensory input display;
b. at least partially in response to detecting the first input, determining a first set of coordinates associated with the first input based on a world coordinate system associated with the work area;
c. determining whether the first set of coordinates is associated with the first portion of the work area or the second portion of the work area;
d. at least partially in response to determining whether the first set of coordinates is associated with the first portion or the second portion, converting the first set of coordinates into a second set of coordinates associated with one of a first coordinate system associated with the first portion and a second coordinate system associated with the second portion; and
e. transmitting the second set of coordinates to the application associated with the one of the first coordinate system and the second coordinate system.

6. The system of claim 1, wherein
a. the multi-sensory input display is a table top display; and
b. the first rendering of the first instance of the application on the first portion is rotated one-hundred and eighty degrees from the second rendering of the second instance on the second portion of the work area so that a first user can sit on a first side of the table top display and a second user can sit on a second side of the table top display that is opposite the first side.

7. The system of claim 1, wherein the system is further configured to:
a. receive the first input in a first editable field for the first application;
b. receive the second input in a second editable field for the second application;
c. at least partially in response to receiving the first input in the first editable field, displaying a first on-screen keyboard in the first portion of the work area; and
d. at least partially in response to receiving the second input in the second editable field, displaying a second on-screen keyboard in the second portion of the work area.

8. The system of claim 7, wherein the first on-screen keyboard and the second on-screen keyboard are displayed substantially simultaneously in its respective portion of the work area.

9. The system of claim 8, wherein the first on-screen keyboard and the second on-screen keyboard are configured to receive input substantially simultaneously.

10. The system of claim 1, wherein the first application is a first instance of a web browser application and the second application is a second instance of a web browser application.

11. The system of claim 1, wherein the first application is a first instances of a web browser and the second application is a first instance of a spreadsheet application.

12. The system of claim 1, wherein the first application is a first instance of a drawing application and the second application is a first instance of a presentation application.

13. A computer-implemented method for collaborating on a multi-sensory input display comprising:
a. executing, on one or more processors, a user interface that is configured to define a work area having a first portion and a second portion;
b. executing a first application and a second application that are both configured to accept input from a user simultaneously with one another;
c. displaying, by one or more processors, the work area on the multi-sensory input display;
d. creating, by one or more processors, a first rendering of the first application in the background;
e. creating, by one or more processors, a second rendering of the second application in the background;
f. displaying, by one or more processors, the first rendering in the first portion of the work area;
g. displaying, by one or more processors, the second rendering in the second portion of the work area;
h. receiving at a first time, by the multi-sensory input display, a first input that is associated with the first portion of the work area;
i. receiving at a second time, by the multi-sensory input display, a second input that is associated with the second portion of the work area;
j. at least partially in response to receiving the first input, determining, by one or more processors, a first change in the first application that corresponds to the first input;
k. at least partially in response to receiving the second input, determining, by one or more processors, a second change in the second application that corresponds to the second input;
l. at least partially in response to determining the first change and the second change to the first and second instances of the application, updating, by one or more processors, the first rendering of the first application and the second rendering of the second application to respectively reflect the first and second changes; and
m. displaying, on the multi-sensory input display, the updated first rendering and the updated second rendering in its respective portion of the work area.

14. The computer-implemented method of claim 13, wherein the step of:
a. displaying the first rendering in the first portion of the work area further comprises displaying a first image of the first rendering in the first portion of the work area; and
b. displaying the second rendering in the second portion of the work area further comprises displaying a second image of the second rendering in the second portion of the work area.

15. The computer-implemented method of claim 14, wherein the step of displaying the updated first rendering and the updated second rendering in its respective portion of the work area further comprises:
a. displaying a third image of the updated first rendering in the first portion of the work area; and
b. displaying a fourth image of the updated second rendering in the second portion of the work area.

16. The computer-implemented method of claim 15, wherein one of the first image and the third image and another of the second and the fourth image are displayed substantially simultaneously on the multi-sensory input display.

17. The computer-implemented method of claim 13, wherein
a. the first time is a first time period with a first beginning time and a first end time; and
b. the second time occurs after the first beginning time and before the first end time of the first time period.

18. The computer-implemented method of claim 13, wherein the second time is substantially the same as the first time.

19. The computer-implemented method of claim 13, wherein the first application is a first instance of an application running in the background and the second application is a second instance of the application running in the background.

20. The computer-implemented method of claim 19, wherein the first application is a web browser.

21. The computer-implemented method of claim 13, wherein the first application is an instance of a web browser application running in the background and the second application is a presentation application also running in the background.

22. A system for allowing two or more users to collaborate in real-time on an interactive display comprising:
a. a multi-sensory input display;
b. one or more processors coupled to the multi-sensory input display;
c. a user interface running on the multi-sensory input display that defines a work area having a first portion and a second portion that is mutually exclusive of the first portion;
d. a first application running on the one or more processors, wherein the first application is in focus at all times; and
e. a second application running on the one or more processors, wherein the second application is in focus at all times;
wherein the system is configured for:
i. displaying the work area for the user interface on the multi-sensory input display;
ii. displaying a first rendering of the first application in the first portion of the work area and a second rendering of the second application in the second portion of the work area;
iii. receiving a first input from a first user on the multi-sensory input display that corresponds to the first application;
iv. receiving a second input from a second user on the multi-sensory input display that corresponds to the second application;
v. at least partially in response to receiving the first input and the second input, determining a first change in the first application and a second change in the second application; and
vi. at least partially in response to determining the first change and the second change, displaying an updated first rendering of the first application in the first portion of the work area and an updated rendering of the second application in the second portion of the work area.
